(19) United States
(12) Patent Application Publication
(10) Pub. No.: US 2010/0159881 A1
(43) Pub. Date: Jun. 24, 2010

(54) ELECTRONIC APPARATUS AND CONTROLLING METHOD

(75) Inventors: Kouichi YASAKI, Kawasaki (JP); Kazuaki Nimura, Kawasaki (JP); Yousuke Nakamura, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/639,559

(22) Filed: Dec. 16, 2009

(30) Foreign Application Priority Data
Dec. 24, 2008 (JP) 2008-328123

(51) Int. Cl. H04M 1/66

(52) U.S. Cl. 455/411

(57) ABSTRACT

A method for controlling a stop and a recovery of a communication function for performing external communication, the method includes acquiring an operation condition of a main body of the computer while the communication function is stopped, determining whether the communication function is recoverable based on the acquired operation condition, and limiting use of the main body of the computer when the communication function is determined to be recoverable.

### CROSS-REFERENCE TO RELATED APPLICATIONS

This application is based upon and claims the benefit of priority of the prior Japanese Patent Application No. 2008-328123, filed on Dec. 24, 2008, the entire contents of which are incorporated herein by reference.

### FIELD

The embodiment discussed herein is related to an electronic apparatus provided with a function to control the stop and recovery of a communication function, and to a controlling method.

### BACKGROUND

In recent years, incidents of an electronic apparatus such as a mobile phone and personal computer being stolen and secret information stored in the electronic apparatus being leaked have occurred. Thus, in the case of a mobile phone, a security system is used to avoid leakage of secret information by disabling the use of the main body of the stolen mobile phone or deleting data after a remote instruction signal is transmitted by the victim.

For such a security system to function, the communication function of a mobile phone needs to continue to function. However, the mobile phone is turned off in a communication prohibited area such as inside an airplane when the airplane takes off or lands, and inside a hospital, stopping the main body function including the communication function. Then, the user may forget to restart the main body function.

Japanese Laid-open Patent Publication No. 1-240026 discloses an apparatus to prevent the user from forgetting to turn on the apparatus.

Japanese Laid-open Patent Publication No. 2006-324829 discloses a mobile phone apparatus capable of restarting an operation thereof.

Japanese Laid-open Patent Publication No. 2006-33852 discloses an apparatus capable of responding to a command from a wireless terminal.

Japanese Laid-open Patent Publication No. 2006-303817 discloses a mobile terminal apparatus capable of performing predetermined information maintenance processing in accordance with remote operation information.

The above mobile phone has feeding control that is common to the main body function and the communication function. However, except for a mobile phone, the feeding controls to the communication function and to the main body function are separate in an electronic apparatus that has no communication function. Therefore, the main body function can be caused to continue the electronic apparatus while only the communication function is stopped.

A conventional apparatus in which, like the above electronic apparatus, a plurality of feeding controls occurs cannot solve the above problem. The conventional apparatus only stops or restarts the communication function in a predetermined area. Moreover, a conventional system needs a base station to manage the area, making expensive facility investment necessary.

### SUMMARY

According to an aspect of the embodiment, a method for controlling a stop and a recovery of a communication function for performing external communication includes acquiring an operation condition of a main body of the computer while the communication function is stopped, determining whether the communication function is recoverable based on the acquired operation condition, and limiting use of the main body of the computer when the communication function is determined to be recoverable.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of an electronic apparatus in the present embodiment;

FIG. 2 is a diagram illustrating a display example of a notification screen in the present embodiment;

FIG. 3 is a diagram illustrating a format example of operation condition data in the present embodiment;

FIG. 4 is a diagram illustrating an example of schedule data in the present embodiment;

FIG. 5 is a diagram illustrating a storage example of a determination information database in the present embodiment;

FIG. 6 is a block diagram illustrating the function of a CPU in the present embodiment;

FIG. 7 is a diagram illustrating corresponding processing performed by the CPU in the present embodiment;

FIG. 8 is a flowchart illustrating the procedure for function recovery processing performed by the CPU in the present embodiment; and

FIG. 9 is a flowchart illustrating the procedure for function recovery determination processing performed by the CPU in the present embodiment.

### DESCRIPTION OF EMBODIMENTS

An electronic apparatus and a computer program according to the present embodiment will be described using the drawings. A portable notebook personal computer (laptop computer) is taken as an example of the electronic apparatus below to describe the electronic apparatus.

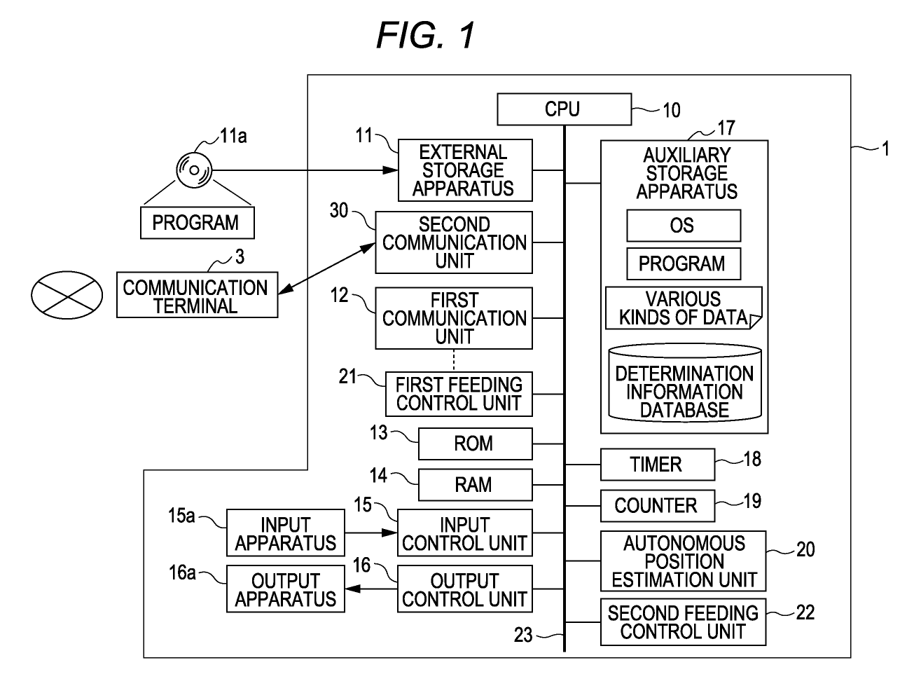

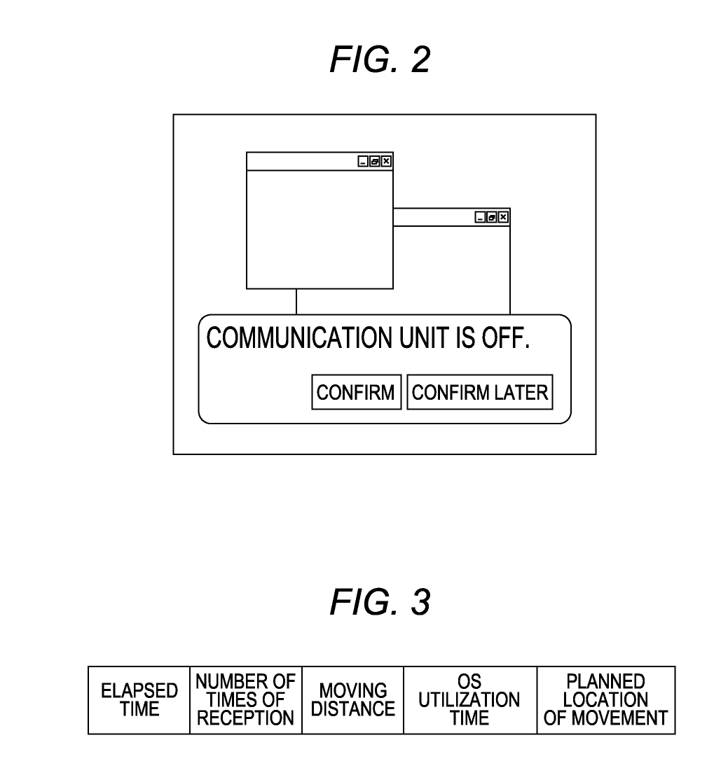

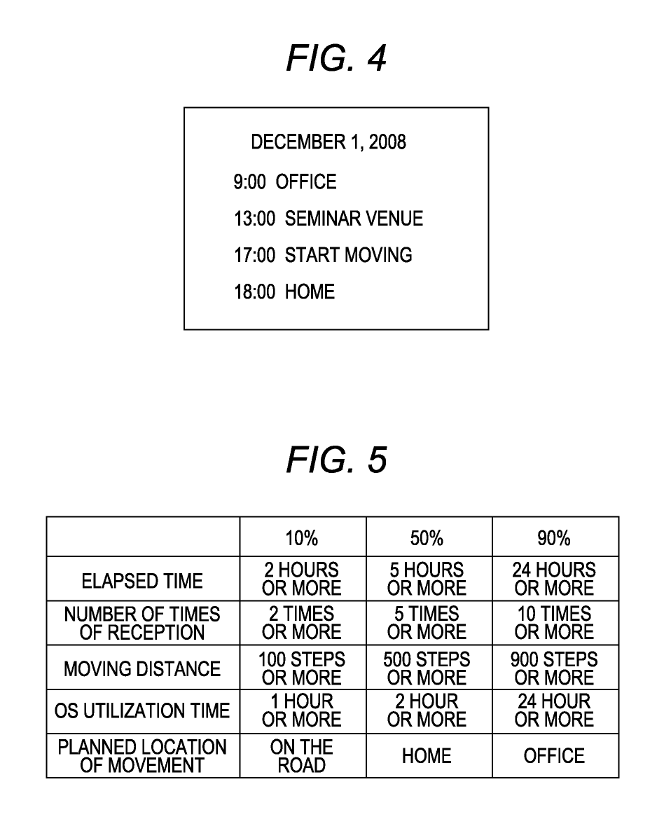

FIG. 1 is a block diagram illustrating the configuration of an electronic apparatus in the present embodiment. FIG. 2 is a diagram illustrating a display example of a notification screen in the present embodiment. FIG. 3 is a diagram illustrating a format example of operation condition data in the present embodiment. FIG. 4 is a diagram illustrating an example of schedule data in the present embodiment. FIG. 5 is a diagram illustrating a storage example of a determination information database in the present embodiment.

In FIG. 1, an electronic apparatus 1 in the present embodiment is illustrated. The electronic apparatus 1 in the present embodiment includes an external storage apparatus 11, a first communication unit 12, a ROM 13, a RAM 14, an input control unit 15, an input apparatus 15a, an output control unit 16, an output apparatus 16a, an auxiliary storage apparatus 17, a timer 18, a counter 19, an autonomous position estimation unit 20, a first feeding control unit 21, a second feeding control unit 22, a second communication unit 30, and a CPU 10. Each unit is mutually connected via a bus 23. The electronic apparatus 1 contains a power supply (not shown) to feed power to each unit.

The external storage apparatus 11 reads recorded data (including programs) of a recording medium 11a and outputs the data to the auxiliary storage apparatus 17. In the present embodiment, programs include, for example, an operating system (hereinafter, referred to as the OS), computer programs, and other application software.

The second communication unit 30 is an example of the communication unit of the electronic apparatus 1. In the present embodiment, the second communication unit 30 may be, for example, a Bluetooth (registered trademark) transmitter/receiver. The second communication unit 30 is able to communicate with an external communication terminal 3 using Bluetooth and communication with the communication terminal 3 is standardized by a profile. The profile includes GAP (Generic Access Profile) and SDAP (Service Discovery Application Profile). The GAP is a profile to connect the communication terminal 3 and to perform authentication and encryption. The SDAP is a profile to examine functions provided by other Bluetooth devices. The profile is stored in a storage area of the second communication unit 30.

The communication terminal 3 is, for example, a mouse, keyboard, or removable disk having a Bluetooth communication function.

The second communication unit 30 and the communication terminal 3 are connected to each other by the procedure below. A connection originator has authentication and encryption set in advance. The connection originator transmits an electric wave to a peripheral device. If the peripheral device has the same authentication and encryption set thereto as the connection originator, the peripheral device transmits a cryptographic key held by the peripheral device to the connection originator. If the connection originator receives the cryptographic key, the connection originator checks the cryptographic key against a key held by the connection originator. If the check is successful, communication between the connection originator and a connection destination is made possible. If the function of the peripheral device is stopped, the connection originator repeatedly transmits an electric wave until the functions are recovered.

The first communication unit 12 is an example of the communication unit of the electronic apparatus 1. In the present embodiment, the first communication unit 12 is a PHS (Personal Handy-phone System) transmitter/receiver. The first communication unit 12 is able to communicate with an external PHS base station using the PHS and is able to connect to a public network such as the Internet via the base station. The first communication unit 12 receives a remote control signal from an external apparatus via the Internet and outputs the received signal to the CPU 10. The CPU 10 controls each unit according to the received remote control signal.

The start (continuation) or stop of feeding of the first communication unit 12 is controlled by the first feeding control unit 21. The feeding of the first communication unit 12 is controlled independent of other units. When feeding is stopped, the function of the first communication unit 12 stops and when feeding is started, the function thereof is recovered.

The first feeding control unit 21 is a switching circuit that switches the start (continuation) and stop of feeding from the power supply to the first communication unit 12. Feeding is switched by the user. When the first feeding control unit 21 receives a feeding stop request, the first feeding control unit 21 outputs the received request to the CPU 10 or Basic Input/Output System (hereinafter, referred to as BIOS). The CPU 10 or BIOS performs authentication processing to stop feeding. The CPU 10 or BIOS outputs an authentication result to the first feeding control unit 21. When an authentication result indicating that there is an authorization is received, the first feeding control unit 21 stops feeding. When an authentication result indicating that there is no authorization is received, on the other hand, the first feeding control unit 21 does not stop feeding. When a feeding start request is received, the first feeding control unit 21 starts feeding without authentication to recover the function of the first communication unit 12.

The ROM 13 is a storage apparatus capable of reading recorded data. The ROM 13 is a semiconductor device that stores a BIOS and other firmware. The BIOS is a kind of firmware and is a system that carries out the lowest-level input/output with each unit. The BIOS is read from the ROM 13 to the RAM 14 when the power supply starts feeding. The BIOS performs activation of the OS, authentication processing, and the like.

The RAM 14 temporarily stores data generated by execution of the CPU 10 or read from the auxiliary storage apparatus 17. The RAM 14 corresponds to a semiconductor such as an SDRAM (Synchronous DRAM) and SRAM (Static RAM).

The input control unit 15 outputs input data received from the input apparatus 15a to the RAM 14 or the auxiliary storage apparatus 17. The input apparatus 15a includes a keyboard, a touch pad, a fingerprint reading unit, and a USB device reading apparatus. The input apparatus 15a accepts a switching request of the start or stop of feeding and other requests to the first feeding control unit 21, fingerprint data, key information, and other identification information inside a USB device, schedule data of the user, and the like. In the present embodiment, a switching request to start feeding corresponds to a recovery request of the function of the first communication unit 12.

The output control unit 16 outputs output data to the output apparatus 16a. The output apparatus 16a includes a liquid crystal monitor and a speaker. Output data is an authentication screen, notification screen, and the like. The authentication screen is a screen used to authenticate a user's authorization and displays types of identification information to be input and has an input field of the identification information.

The notification screen is a screen used to prompt the user to request the start of feeding and displays a message that feeding to the first communication unit 12 is stopped and has operation buttons (see FIG. 2). The operation buttons are pressed in accordance with input into the input apparatus 15a. The operation buttons include a “Confirm” button and a “Confirm later” button. The “Confirm” button is pressed when the start of feeding is requested. The “Confirm later” button is pressed when a request to start feeding is canceled. The output control unit 16 is controlled by the CPU 10.

When the “Confirm” button is pressed, the output control unit 16 ends the display of the notification screen. When the “Confirm later” button is pressed, the output control unit 16 temporarily ends the display of the notification screen and redisplays the notification screen after a specific time passes. The specific time will be described later. The user is temporarily prevented from using the electronic apparatus by the display of the notification screen. That is, a moderate restriction may be imposed on the use of an electronic apparatus by the user of the electronic apparatus according to the degree of conditions in which the function of the communication unit held by the electronic apparatus may be allowed to be recovered. Accordingly, the user may be prompted to recover the function of the communication unit held by the electronic apparatus.

The auxiliary storage apparatus 17 stores data received from the external storage apparatus 11, the first communication unit 12, the ROM 13, the RAM 14, the input control unit 15, or the second communication unit 30, and reads data when appropriate. The auxiliary storage apparatus 17 corresponds to a hard disk drive (HDD) in the magnetic disk recording mode or a flash solid state drive (Flash SSD) constructed of NAND elements. In the present embodiment, the auxiliary storage apparatus 17 stores the OS, other programs, various kinds of data, and a determination information database. Various kinds of data include operation condition data, schedule data, and user identification information.

In the present embodiment, operation condition data is data acquired by the CPU 10 from the timer 18, the counter 19, the autonomous position estimation unit 20, and/or the second communication unit 30. The operation condition data includes the elapsed time, number of times of receiving a signal, moving distance, OS utilization time, and planned destination (see FIG. 3). The elapsed time is an elapsed time after feeding to the first communication unit 12 is stopped. The number of times of receiving a signal is the number of times of receiving an electric wave transmitted from the communication terminal 3. The moving distance is a moving distance of the electronic apparatus 1, that is, a moving distance of the user carrying the electronic apparatus 1. The OS utilization time is a time during which the OS is activated and used by the BIOS. The planned destination is a planned location of a movement destination of the electronic apparatus 1, that is, a planned location of a movement destination of the user carrying the electronic apparatus 1. The acquisition method of the operation condition data will be described later.

In the present embodiment, the schedule data is data on the movement destination of the user and includes the planned time and movement destination (see FIG. 4). The movement destination is a destination to which the user moves at a planned time. The movement destination is, for example, on the road, the user's home, or the office where the user works. The planned time is acquired by a clock/watch function of the timer 18 described later. The schedule data is preset by the user.

In the present embodiment, the determination information database stores the degree of possibility that the function of the first communication unit 12 recovers after starting feeding to the first communication unit 12 and a threshold (see FIG. 5) in association with each other. In the present embodiment, the degree is represented in percentage points and an increasing value thereof indicates that the recovery of the function of the first communication unit 12 is more likely. The threshold is an index value indicating operation conditions where the function of the first communication unit 12 recovers, and is set for each operation condition. The threshold and degree are preset by the user. The threshold and degree are associated with each other for each operation condition.

In the present embodiment, the threshold and degree are set in such a way that the degree is set to 10% when the elapsed time is two hours or more, 50% when the elapsed time is five hours or more, and 90% when the elapsed time is 24 hours or more. This is because the reason for stopping feeding disappears and the possibility that the function of the first communication unit 12 recovers grows as the stop time of feeding to the first communication unit 12 increases. The reasons for stopping feeding include, for example, being inside an airplane when the airplane takes off or lands, being in a hospital, and being in the vicinity of a patient using a pace maker, and the like.

As another example of a threshold and a degree, the degree is set to 10% when the number of times of receiving a signal is two times or more, 50% when the number of times of receiving a signal is five times or more, and 90% when the number of times of receiving a signal is 10 times or more. This is because the possibility of being positioned in an area where an electric wave may be used grows and also the possibility that the function of the first communication unit 12 recovers grows with an increasing number of times of receiving an electric wave transmitted from the communication terminal 3.

As still another example of a threshold and a degree, the degree is set to 10% when the moving distance is 100 steps or more, 50% when the moving distance is 500 steps or more, and 90% when the moving distance is 900 steps or more. This is because the possibility of leaving a communication prohibited area grows and also the possibility that the function of the first communication unit 12 recovers grows with an increasing moving distance. The example illustrated in FIG. 5 is an example in which feeding to the first communication unit 12 is controlled in accordance with the moving distance based on the number of steps of the user carrying the electronic apparatus 1. As another example, feeding to the first communication unit 12 is controlled in accordance with a traveling time obtained by accumulating the unit time in which the number of steps of the user carrying the electronic apparatus 1 is detected in a specific unit of time. For example, the degree may be associated with 10% when the traveling time is two minutes or more, 50% when the traveling time is 10 minutes or more, and 90% when the traveling time is 20 minutes or more. That is, it is only desirable that the degree indicating the possibility of a determination that feeding to the first communication unit 12 may start in accordance with movement of the user carrying the electronic apparatus 1 is associated and managed.

As still another example of a threshold and a degree, the degree is set to 10% when the OS utilization time is one hour or more, 50% when the OS utilization time is two hours or more, and 90% when the OS utilization time is 24 hours or more. This is because the possibility that the reason for stopping feeding disappears grows and also the possibility that the function of the first communication unit 12 recovers grows with an increasing OS utilization time.

As still another example of a threshold and a degree, the degree is set to 10% while on the road, 50% when the planned destination is the user's home, and 90% when the planned destination is the user's office. The degree for the office increases because the communication unit is indispensable in the office. The degree for the user's home is a medium degree because while the communication unit is used in the user's home, there may be a special reason such as being in the vicinity of a patient using a pace maker. The degree while on the road is low because there are many reasons such as being inside an airplane when the airplane takes off or lands, being in a hospital, and being in the vicinity of a patient using a pace maker in a train, and the like.

The timer 18 is a circuit having a stopwatch function to measure an elapsed time since the start time and a clock/watch function to measure what percentage of the daytime has passed (time). The timer 18 is controlled by the CPU 10. The timer 18 outputs a measurement result to the CPU 10.

The counter 19 is a circuit to count the number of times of receiving an electric wave transmitted from the communication terminal 3. The counter 19 is controlled by the CPU 10. The counter 19 outputs a measurement result to the CPU 10.

The autonomous position estimation unit 20 is a circuit to calculate the moving distance of the electronic apparatus 1. In the present embodiment, the autonomous position estimation unit 20 includes an acceleration sensor and a gyro-sensor. The autonomous position estimation unit 20 detects gravity and acceleration on the electronic apparatus 1 and detects the number of steps of the user carrying the electronic apparatus 1. The autonomous position estimation unit 20 is controlled by the CPU 10. The autonomous position estimation unit 20 outputs a calculation result to the CPU 10.

The second feeding control unit 22 is a switching circuit that switches the start and stop of feeding from the power supply to each unit other than the first communication unit 12. The second feeding control unit 22 is switched by the user. When a feeding start request is received, the second feeding control unit 22 starts feeding to each unit. With the start of feeding, the BIOS is read from the ROM 13 to the RAM 14. The BIOS reads the OS from the auxiliary storage apparatus 17 to activate the OS. When a feeding stop request is received, the second feeding control unit 22 terminates the OS and stops feeding to each unit.

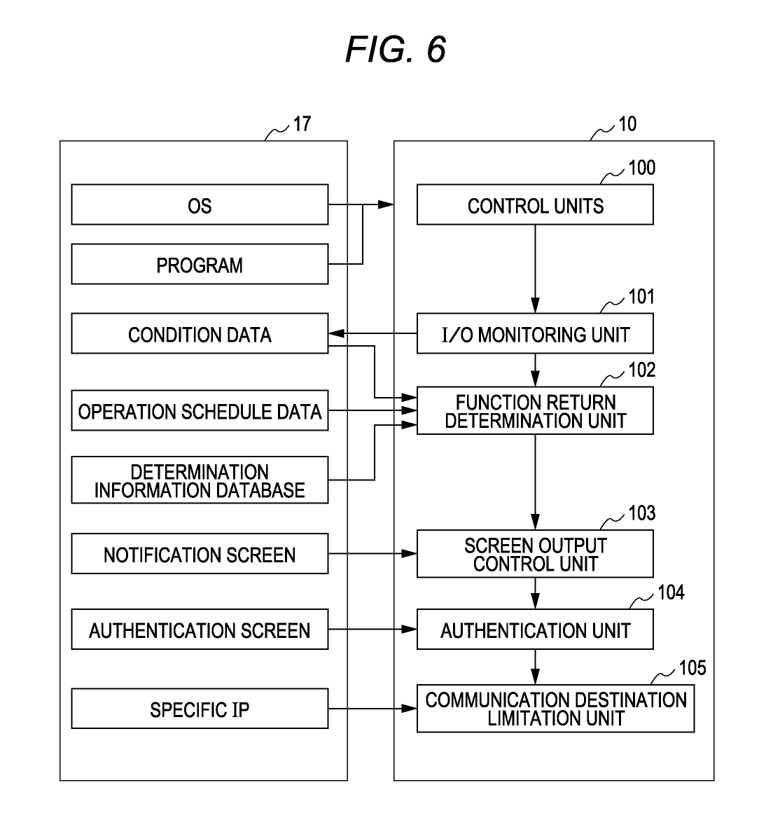

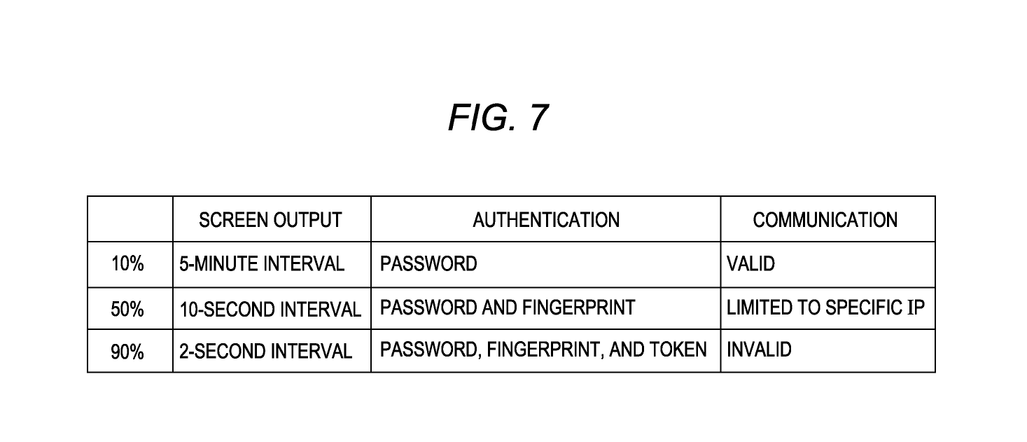

FIG. 6 is a block diagram illustrating the function of the CPU 10 in the present embodiment and FIG. 7 is a diagram illustrating corresponding processing performed by the CPU 10 in the present embodiment. The CPU 10 executes a plurality of functions below based on the above OS, application software, various kinds of data, and determination information database.

(Control Unit 100)

The CPU 10 functions as the control unit 100 that controls each unit according to the OS, other programs, or a remote control signal.

(I/O Monitoring Unit 101)

The CPU 10 functions as the I/O monitoring unit 101. The CPU 10 monitors operation conditions of the first communication unit 12, the timer 18, the counter 19, the autonomous position estimation unit 20, and other units. After receiving measurement results from the timer 18 and the autonomous position estimation unit 20, the CPU 10 registers the measurement results as operation condition data. When the second communication unit 30 receives an electric wave, the CPU 10 detects a count signal generated inside the second communication unit 30 by the electric wave and outputs the detected count signal to the counter 19. The CPU 10 receives a measurement result from the counter 19 and registers the measurement result as operation condition data. Thus, the electronic apparatus 1 according to the present embodiment is able to grasp operation conditions of the electronic apparatus 1. Further, even if the communication function is stopped, the electronic apparatus 1 is able to grasp operation conditions of the electronic apparatus 1.

(Function Recovery Determination Unit 102)

The CPU 10 functions as a function recovery determination unit 102. The CPU 10 reads operation condition data, schedule data, and the determination information database from the auxiliary storage apparatus 17. The CPU 10 determines whether feeding to the first communication unit 12 may be started by comparing the operation condition data and schedule data and the determination information database. The CPU 10 also calculates the degree to which feeding may be started. Thus, the electronic apparatus 1 according to the present embodiment may determine the possibility of the recovery of the function of the first communication unit 12 unassisted so that no base station is needed. The function thereof may be stopped or restarted even outside a specific area. Moreover, forgetting to restart the stopped feeding may be reduced if not prevented.

(Screen Output Control Unit 103)

If the CPU 10 determines that feeding to the first communication unit 12 may be started, the CPU 10 functions as a screen output control unit 103. The CPU 10 reads notification screen data from the auxiliary storage apparatus 17. The CPU 10 outputs the read notification screen data to the output control unit 16. The CPU 10 decides a specific time in accordance with a calculated degree. If the “Confirm later” button in the notification screen is pressed, the CPU 10 temporarily ends the display of the notification screen via the output control unit 16 before causing the screen output control unit 103 to display the notification screen when the specific time passes. If the “Confirm” button in the notification screen is pressed, the CPU 10 causes the screen output control unit 103 to end the display of the notification screen.

The specific time is desired, for example, as a 5-minute interval when the degree is 10%, as a 10-second interval when the degree is 50%, and as a 2-second interval when the degree is 90% (see FIG. 7). This is because the possibility that the function of the first communication unit 12 recovers grows with an increasing degree and therefore, the user is prompted to request the start of feeding. That is, the user is temporarily prevented from using an electronic apparatus by the display of the notification screen. Particularly a moderate restriction may be imposed on the use of an electronic apparatus by the user of the electronic apparatus by changing the display frequency of the notification screen according to the degree of conditions in which the function of the communication unit held by the electronic apparatus may be allowed to recover. Accordingly, the user may suitably be prompted to allow the function of the communication unit held by the electronic apparatus to recover.

(Authentication Unit 104)

If the CPU 10 determines that feeding to the first communication unit 12 may be started, the CPU 10 functions as an authentication unit 104. The CPU 10 reads authentication screen data from the auxiliary storage apparatus 17. The CPU 10 decides the type of identification information in accordance with the calculated degree. The CPU 10 outputs an authentication screen, into which decided identification information is input, to the output control unit 16. When all identification information is input via the authentication screen, the CPU 10 performs authentication processing based on the input identification information. If the CPU 10 determines that the user is authorized as a result of authentication, the CPU 10 starts a specific processing. If the CPU 10 determines that the user is not authorized, the CPU 10 stops the specific processing. Specific processing that needs an authentication request includes the activation of the OS, stop of feeding, recovery from the suspension mode, installation of application software, and registration of various settings.

The type of identification information is decided, for example, as a password when the degree is 10%, as a password and fingerprint data when the degree is 50%, and as a password, fingerprint data, and a token when the degree is 90% (see FIG. 7). The password is a unique identification number granted to the user and is input into the keyboard. The fingerprint data is fingerprint data of the user and is input into a fingerprint-reading unit. The token is a security token and key information stored in a USB device owned by the user. The token is input into a USB device reading apparatus. An authentication request is made stricter with an increasing degree to prompt the user to request the start of feeding. That is, the user is prevented from using an electronic apparatus by the display of the authentication screen. Particularly a moderate restriction may be imposed on the use of an electronic apparatus by the user of the electronic apparatus by increasing the types of authentication with an increasing degree of conditions in which the function of the communication unit held by the electronic apparatus may be allowed to recover. Accordingly, the user may suitably be prompted to allow the function of the communication unit held by the electronic apparatus to recover. While the communication function is stopped, data erasure by the above remote control cannot be executed. That is, it becomes impossible to prevent leakage of secret information and thus, a self-defense mechanism is made so that unauthorized use may be reduced if not prevented.

(Communication Destination Limitation Unit 105)

If the CPU 10 determines that feeding to the first communication unit 12 may be started, the CPU 10 functions as a communication destination limitation unit 105. The CPU 10 decides limitations of the communication destination in accordance with a calculated degree. The CPU 10 communicates with only limited communication destinations.

Limitations of the communication destination are decided, for example, as making communication with all communication destinations valid when the degree is 10%, as limiting communication destinations to specific IPs when the degree is 50%, and as making communication with all communication destinations invalid when the degree is 90% (see FIG. 7). Specific IPs indicate destinations of communicable terminals and are stored in the auxiliary storage apparatus 17 and preset by the user. This is intended to prompt the user to request the start of feeding by limiting communication destinations in accordance with an increasing degree. That is, the user is prevented from using an electronic apparatus by limiting the communication function of the second communication unit 30. Particularly a moderate restriction may be imposed on the use of an electronic apparatus by the user of the electronic apparatus by increasing the degree of limiting the communication function of the second communication unit 30 with an increasing degree of conditions in which the function of the communication unit (the first communication unit 12) held by the electronic apparatus may be allowed to recover. Accordingly, the user may suitably be prompted to allow the function of the communication unit held by the electronic apparatus to recover.

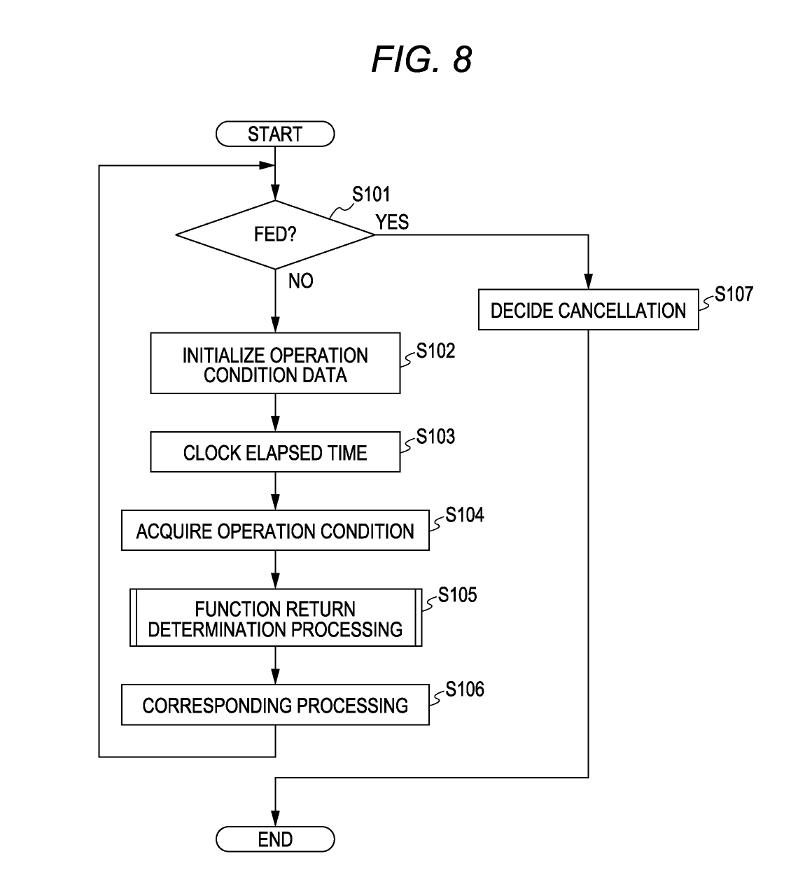

The CPU 10 of the electronic apparatus 1 performs processing below by causing initiation of the above functions. FIG. 8 is a flowchart illustrating the procedure for function recovery processing performed by the CPU 10 in the present embodiment. The CPU 10 determines whether the first communication unit 12 is fed (S101). When a feeding stop request is received, the first feeding control unit 21 stops feeding to the first communication unit 12. If a feeding start request is received on the other hand, the first feeding control unit 21 starts feeding to the first communication unit 12.

If the CPU 10 determines that feeding is stopped (NO at S101), the CPU 10 initializes operation condition data (S102). The CPU 10 causes the stopwatch function of the timer 18 to measure an elapsed time from the feeding stop (S103). The CPU 10 receives a measurement result from the timer 18.

The CPU 10 acquires other operation conditions (S104). The CPU 10 causes the counter 19 to count the number of times of receiving an electric wave and receives a counting result. The CPU 10 also causes the autonomous position estimation unit 20 to detect the moving distance and receives a result thereof. The CPU 10 causes the stopwatch function of the timer 18 to measure the OS utilization time and receives a measurement result. The CPU 10 also extracts planned destinations from the schedule data.

Based on acquired operation conditions, the CPU 10 performs function recovery determination processing to determine the possibility that the function of the first communication unit 12 recovers (S105). The procedure for function recovery determination processing will be described later.

The CPU 10 performs corresponding processing in accordance with a result of the function recovery determination processing (S106). In the present embodiment, the corresponding processing includes the output of the notification screen by the screen output control unit 103, an authentication request by the authentication unit 104, and limitation of the communication destination by the communication destination limitation unit 105. The CPU 10 returns to step S101 to determine whether the first communication unit 12 is fed or not.

On the other hand, if the CPU 10 determines at step S101 that feeding to the first communication unit 12 is started (YES at S101), the CPU 10 decides cancellation of the above corresponding processing (S107). The CPU 10 terminates the function recovery processing.

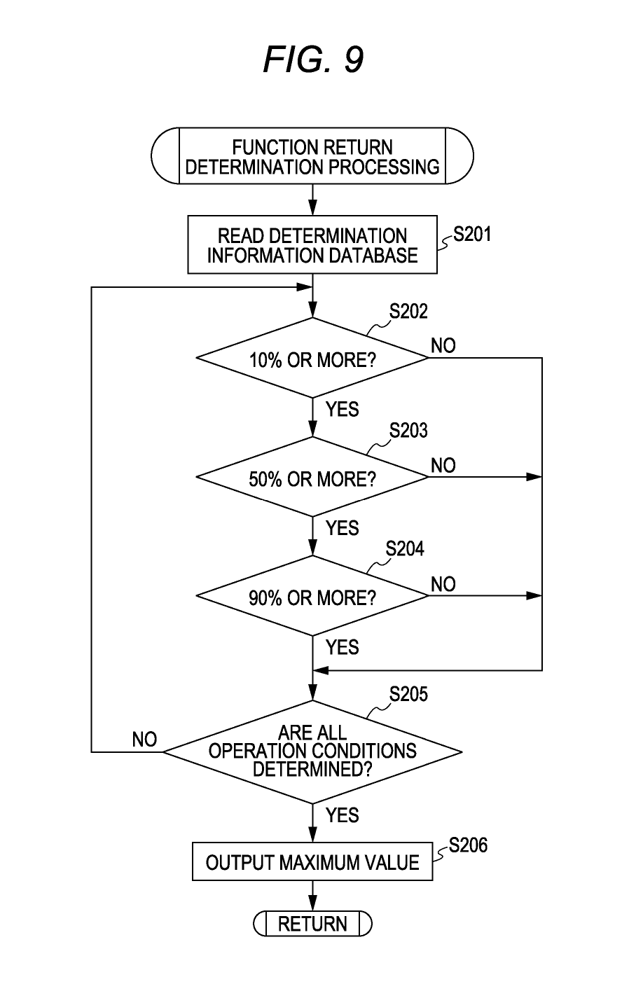

Next, the procedure for function recovery determination processing at step S105 will be described. FIG. 9 is a flowchart illustrating the procedure for function recovery determination processing performed by the CPU 10 in the present embodiment. The CPU 10 of the electronic apparatus 1 reads the determination information database from the auxiliary storage apparatus 17 (S201).

The CPU 10 compares acquired operation conditions (the elapsed time, number of times of reception, moving distance, OS utilization time, or planned destination) with the determination information database one by one. The CPU 10 extracts the degree corresponding to the acquired operation conditions from the determination information database. The CPU 10 determines whether the extracted degree is 10% or more (S202). If the CPU 10 determines that the degree is less than 10% (NO at S202), the CPU 10 continues to step S205.

On the other hand, if the CPU 10 determines that the degree is 10% or more (YES at S202), the CPU 10 determines whether the degree is 50% or more (S203). If the CPU 10 determines that the degree is less than 50% (NO at S203), the CPU 10 continues to step S205.

On the other hand, if the CPU 10 determines that the degree is 50% or more (YES at S203), the CPU 10 determines that the degree is 90% or more (S204). The CPU 10 continues to step S205.

If the degree is determined to be less than 10% (NO at S202), less than 50% (NO at S203), less than 90% (NO at S204), or 90% more (YES at S204), the CPU 10 determines whether the above determination is made for all operation conditions (S205). If the CPU 10 determines that the above determination is not made for all of the operation conditions (NO at S205), the CPU 10 returns to step S202.

On the other hand, if the CPU 10 determines that the above determination is made for all the operation conditions (YES at S205), the CPU 10 selects the maximum value from the selected degrees. The CPU 10 outputs the selected maximum value (S206). The CPU 10 returns to the function recovery processing. If any one of the operation conditions meets the threshold, the CPU 10 performs the function recovery processing.

In the above embodiment, an example in which the Bluetooth transmitter/receiver is the second communication unit 30 has been described. However, the disclosed electronic apparatus is not limited to such an example, and a Wi-Fi (registered trademark) transmitter/receiver may be a communication unit. The transmitter/receiver may be, instead of a wireless transmitter/receiver, a wire transmitter/receiver.

In the above embodiment, an example in which the PHS transmitter/receiver is the first communication unit 12 has been described. However, the disclosed electronic apparatus is not limited to such an example and may be a WiMAX (registered trademark) transmitter/receiver or a mobile phone module supporting the HSPA (High Speed Packet Access) mode.

In the above embodiment, an example in which the corresponding processing performed by the CPU 10 of the electronic apparatus 1 includes output of the notification screen, an authentication request, and limitation of the communication destination has been described. However, the disclosed electronic apparatus is not limited to such an example and the corresponding processing may include processing such as lowering the resolution of a liquid crystal monitor, lowering the reaction speed of the keyboard, outputting a warning sound, or limiting the function of another electronic apparatus, and the like.

In the above embodiment, an example in which the user is prompted to request the start of feeding when it is determined that there is a possibility that the function of the first communication unit 12 recovers has been described. However, the disclosed electronic apparatus is not limited to such an example and the electronic apparatus may start feeding autonomously.

In the above embodiment, an example in which operation condition data includes five types, i.e., the elapsed time, number of times of receiving an electric wave, moving distance, OS utilization time, and planned destination has been described. However, the disclosed electronic apparatus is not limited to such examples and operation condition data may include any combination of the five types. Alternatively, the number of times of receiving a communication request input by the user or the number of times of activating/terminating the OS may be included.

In the above embodiment, an example in which the degree of possibility that the function of the first communication unit 12 recovers is expressed in terms of percentage has been described. However, the disclosed electronic apparatus is not limited to such an example and the degree may be expressed by another method of ratio.

In the above embodiment, an example in which three degrees are used has been described. However, the disclosed electronic apparatus is not limited to such an example and any number of degrees may be used.

In the above embodiment, an example in which the electronic apparatus 1 is a notebook personal computer has been described. However, the disclosed electronic apparatus is not limited to such an example and may be any apparatus in which the feeding control to the communication unit is independent of the feeding control to the main body such as a communicable car navigation system.

In the above embodiment, an example in which the stop or recovery of the function of the first communication unit 12 is executed by using the stop or start of feeding has been described. However, the disclosed electronic apparatus is not limited to such an example and the function of the OS kernel may be used to execute the stop or recovery of the function.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An electronic apparatus for controlling a stop and a recovery of a function of a communication unit to perform external communication, the apparatus comprising:
an acquisition unit for acquiring an operation condition of a local device while the function of the communication unit is stopped;
a determination unit for determining whether the function of the communication unit is able to be recovered based on the acquired operation condition; and
a control unit for limiting a use of the local machine when the function of the communication unit is determined to be recoverable.

2. The electronic apparatus according to claim 1, further comprising:
a reception unit for receiving a recovery request of the function of the communication unit,
wherein, when the recovery request is received, the function of the communication unit is recovered.

3. The electronic apparatus according to claim 1, further comprising:
a database storing a threshold to indicate the operation condition in which the function of the communication unit is recoverable,
wherein, the determination unit determines whether the function of the communication unit is recoverable based on a relationship between the acquired operation condition and the threshold stored in the database.

4. The electronic apparatus according to claim 3, wherein the database stores the threshold and a degree of recoverability of the function of the communication unit in association with each other, and
the determination unit further
acquires the degree of recoverability based on a relationship between the acquired operation condition and the threshold stored in the database, and
changes contents of a usage limitation of the local machine based on the acquired degree of recoverability.

5. The electronic apparatus according to claim 1, wherein the operation condition is an elapsed time after the function of the communication unit is stopped, and
the acquisition unit measures the elapsed time.

6. The electronic apparatus according to claim 1, wherein the operation condition is a number of times of receiving a signal transmitted from outside after the function of the communication unit is stopped, and
the acquisition unit counts the number of times of receiving the signal.

7. The electronic apparatus according to claim 1, wherein the operation condition is a moving distance of the local machine after the function of the communication unit is stopped, and
the acquisition unit measures the moving distance.

8. The electronic apparatus according to claim 1, wherein the operation condition is a utilization time of the local machine after the function of the communication unit is stopped, and
the acquisition unit measures the utilization time.

9. The electronic apparatus according to claim 1, further comprising:
a storage unit for storing a planned destination of the local machine,
wherein the operation condition is the planned destination of the local machine after the function of the communication unit is stopped, and
the acquisition unit extracts the planned destination of the local machine from the storage unit.

10. The electronic apparatus according to claim 1, further comprising:
an output unit capable of displaying a notification screen prompting the recovery request,
wherein, when the function of the communication unit is determined to be recoverable, the control unit causes the output unit to display the notification screen.

11. The electronic apparatus according to claim 1, further comprising:
an authentication unit for determining whether or not there is a use authority to use the local machine,
wherein, when the function of the communication unit is determined to be recoverable, the control unit causes the authentication unit to determine whether or not the use of the local machine is authorized.

12. The electronic apparatus according to claim 1, further comprising:
a communication limitation unit for limiting communication destinations with which the local machine is allowed to communicate,
wherein, when the function of the communication unit is determined to be recoverable, the control unit causes the communication limitation unit to limit the communication destinations.

13. The electronic apparatus according to claim 1, wherein the communication unit performs wireless communication.

14. The electronic apparatus according to claim 1, further comprising:
receiving a signal from outside,
wherein, remote control is activated according to the received signal.

15. An electronic apparatus provided with a communication unit that performs external communication and capable of controlling a stop and a recovery of a function of the communication unit, the apparatus comprising:
a detection unit for detecting an operation condition of a local machine when the function is stopped;
a determination unit for determining a possibility of the recovery based on the detected operation condition; and
a control unit for performing specific processing when the recovery is determined to be possible.

16. The electronic apparatus according to claim 15, further comprising:
a reception unit for receiving a recovery request of the function,
wherein, when the recovery request is received, the function of the communication unit is recovered.

17. The electronic apparatus according to claim 15, further comprising:
a storage unit for storing a threshold indicating a magnitude of the possibility of the recovery in association with each operation condition,
wherein the determination unit determines the possibility of the recovery based on a relationship between the detected operation condition and the threshold stored in the storage unit.

18. The electronic apparatus according to claim 17, wherein the storage unit stores an index value indicating a degree of the possibility of the recovery in association with each operation condition, and
the determination unit includes:
calculating the degree of the possibility of the recovery based on the relationship between the detected operation condition and the index value stored in the storage unit; and
determining the possibility of the recovery based on the calculated degree.

19. A method for controlling a stop and a recovery of a communication function for performing external communication, the method comprising:
acquiring an operation condition of a main body of the computer while the communication function is stopped:
determining whether the communication function is recoverable based on the acquired operation condition; and
limiting a use of the main body of the computer when the communication function is determined to be recoverable.

20. A computer-readable storage medium storing a program for controlling a stop and a recovery of a communication function for performing external communication, the program causing a computer to execute:
acquiring an operation condition of a main body of a computer while the communication function is stopped:
determining whether the communication function is recoverable based on the acquired operation condition; and
limiting a use of the main body of the computer when the communication function is determined to be recoverable.
